(19) United States
(12) Patent Application Publication
(10) Pub. No.: US 2017/0253218 A1
(43) Pub. Date: Sep. 7, 2017

(54) WINDSHIELD WIPER BLADE ARRANGEMENT

(71) Applicant: Matthias Raber, Cochranton, PA (US)

(72) Inventor: Matthias Raber, Cochranton, PA (US)

(21) Appl. No.: 15/059,433

(22) Filed: Mar. 3, 2016

(51) Int. Cl. B60S 1/38

(52) U.S. Cl. CPC B60S 1/38; B60S 2001/3829

(57) ABSTRACT

A wiper blade for improved wiping capabilities including: a blade surface; a plurality of micro blades diagonally aligned across the blade surface; and a preset distance between each micro blade. Preferably, wiper blade is 0.5 inches in width and 3 mm in thickness. The micro blades are preferably 3 mm in width and 6mm in length.

### BACKGROUND OF THE INVENTION

Field of Invention

The present invention relates to a windshield wiper blade that includes an arrangement of microblades across the surface to provide improved wiping strength.

Description of Related Art

Windshield wiper blades serve to clear windshields of moisture and/or debris while operating a motor vehicle. Wiper blades are also used on other vehicles such as boats, trains and airplanes. However principally wiper blades are known for use on a motor vehicle windshield. The blade is placed on an arm assembly and rotated across the surface of the windshield during use. This rotation helps to clear the windshield and provide the driver with a clear view while operating a motor vehicle. However in certain instances residue can build up over the windshield regardless of the wiper blade use. This residue may be due to bugs, dusts, mud, bird droppings or other types of residue that could impede the view of the driver. Many times individuals must stop and clean their windshields manually with manual wipers and towels in order to remove hard-to-remove debris. As a result there is always a desire and need for improved wiper blades that could easily clear the surface of a windshield during operation.

### SUMMARY OF THE INVENTION

The present invention relates to a wiper blade for improved wiping capabilities including: a blade surface; a plurality of micro blades diagonally aligned across the blade surface; and a preset distance between each micro blade. Preferably, wiper blade is 0.5 inches in width and 3 mm in thickness. The micro blades are preferably 3 mm in width and 6mm in length.

### BRIEF DESCRIPTION OF DRAWINGS

FIG. 1 depicts a surface of a wiper blade in accordance with the present invention.

### DETAILED DESCRIPTION

The present invention relates to a wiper blade that is used as a replacement blade for wiping windshields. The wiper blade according to the present invention has a wiper blade surface that includes a plurality of microblades across the surface of the blade. The microblades are diagonally positioned and provide increased wiping capabilities for the wiper blade according to the present invention. Although the microblades align the wiper blade surface and increase the wiping capabilities of the blade according to the present invention.

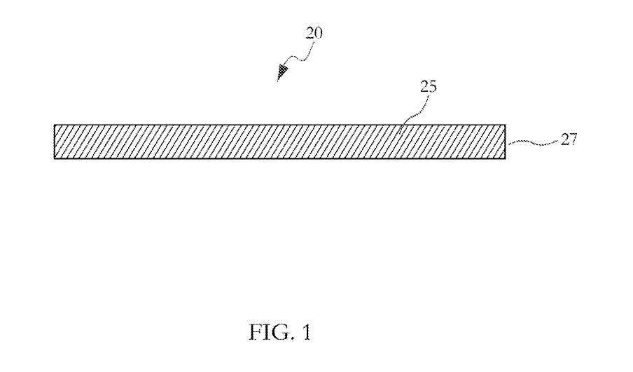

FIG. 1 depicts a Wiper Blade 20 in accordance with the present invention. The Wiper Blade 20 includes a blade surface that has a series of Microblades 25 across the surface thereof. The Microblades 25 diagonally align and cover the entire blade surface. This blade 20 provides increasing wiping capabilities due to the multitude of microblades across the surface. The Blade Height 27 may vary and preferably is about 0.5″. The depth of the Wiper Blade 20 although not shown may also vary in thickness and may be up to 3 millimeters in thickness. The Microblades 25 preferably are 3 millimeters in thickness and about 6 millimeters in length aligned across the surface of the Wiper Blade 20 as shown in FIG. 1. Use of the Wiper Blade 20 provides an effective means to provide improved cleaning of a windshield. The instant invention has been shown and described in what it considers to be the most practical and preferred embodiments. It is recognized, however, that departures may be made there from within the scope of the invention and that obvious modifications will occur to a person skilled in the art.

What is claimed is:

1. A wiper blade for improved wiping capabilities comprising:
a. a blade surface;
b. a plurality of micro blades diagonally aligned across the blade surface; and
c. a preset distance between each micro blade.

2. The wiper blade according to claim 1, where the blade is 0.5 inches in width.

3. The wiper blade according to claim 1, where the blade is 3 mm in thickness.

4. The wiper blade according to claim 1, where micro blades are 3 mm in thickness and 6 mm in length.
